(19) United States
(12) Patent Application Publication
(10) Pub. No.: US 2025/0159577 A1
(43) Pub. Date: May 15, 2025

(54) NETWORK RECOMMENDED SEAMLESS ROAMING

(71) Applicant: QUALCOMM Incorporated, San Diego, CA (US)

(72) Inventors: Abhishek Pramod PATIL, San Diego, CA (US); Gaurang NAIK, San Diego, CA (US); Sai Yiu Duncan HO, San Diego, CA (US); Alfred ASTERJADHI, San Diego, CA (US); George CHERIAN, San Diego, CA (US)

(21) Appl. No.: 18/506,831

(22) Filed: Nov. 10, 2023

(51) Int. Cl. H04W 36/18; H04W 8/02

(52) U.S. Cl. CPC H04W 36/18; H04W 8/02

(57) ABSTRACT

This disclosure provides techniques that enable a network entity to indicate recommendations, to a wireless station (STA), for seamless roaming. For example, a single mobility domain (SMD) entity with knowledge of various access points (APs), for example regarding loading and capability, may be able to recommend a set of one or more APs that may be most suitable as targets for the STA to transition to.

### TECHNICAL FIELD

This disclosure relates generally to wireless communication, and more specifically, to techniques that enable a network entity to indicate recommendations, to a wireless station, for seamless roaming.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In wireless systems (such as IEEE 802.11 compliant networks), wireless stations (STAs) often roam between the coverage areas of different access points (APs). In conventional systems, as a STA roams, the STA is handed over from a source AP (currently serving the STA) to a target AP. As part of such a handover procedure, the STA typically needs to re-associate with the target AP. Re-association is typically needed before the network can switch the data path from the source AP to the target AP. Unfortunately, the re-association procedure may be relatively time consuming and interrupts data flow, which may adversely impact user experience.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication at a first wireless node. The method includes establishing association with a single mobility domain (SMD) entity; communicating with a first set of one or more serving access point (AP) devices affiliated with the SMD entity; obtaining at least a first frame indicating one or more AP devices affiliated with the SMD entity; selecting a second set of one or more target AP devices after obtaining the at least a first frame; and transitioning from the first set to the second set.

Another aspect provides a method for wireless communication at a second wireless node. The method includes generating at least a first frame indicating one or more serving AP devices affiliated with a single mobility domain (SMD) entity, wherein the second wireless node is also affiliated with the SMD entity; outputting the at least the first frame to a first wireless node affiliated with the SMD entity; and participating, after outputting the first frame, in a procedure to transition the first wireless node from a first set of one or more serving AP devices to a second set of one or more serving AP devices.

Other aspects provide: an apparatus (e.g., wireless node/wireless station/wireless access point/wireless communication device) operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 depicts a block diagram of an example multi-link device (MLD) deployment.

FIG. 3 depicts an example multi-link operation (MLO) architecture.

FIG. 4 depicts an example call flow diagram illustrating a station initiated handover.

FIG. 5 depicts an example call flow diagram illustrating a network initiated handover.

FIG. 6 depicts an example single mobility domain (SMD) MLD deployment hierarchy.

FIG. 7 depicts an example call flow diagram illustrating network recommended seamless roaming.

FIG. 8 depicts a flowchart illustrating an example method for wireless communication.

FIG. 9 depicts a flowchart illustrating an example method for wireless communication.

FIG. 10 depicts a block diagram of an example wireless communications device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Aspects of the present disclosure provide apparatuses, methods, processing systems, and computer-readable mediums for network recommended seamless roaming.

In conventional wireless communication systems, when a wireless station (STA) roams between multiple access points (APs), the STA needs to re-associate with a new (target) AP and perform an association procedure (e.g., including a 4-way handshake procedure). The 4-way handshake procedure generally refers to a process of exchanging of four messages between an AP and a non-AP MLD to generate and exchange various encryption keys used encrypt data sent between the AP and STA. This four-message exchange may cause undue delay when a STA roams between APs, but needs to be performed before the network can switch the data path. Thus, this type of roaming or handover between APs is referred to as a break-before-make handover, because the connection to the serving AP is broken before the connection to the target AP is made, which creates data interruption and extra delay during the handover procedure.

To address this issue, techniques disclosed herein may take advantage of features of a multi-link operation (MLO) architecture that enable seamless roaming of a STA between APs without needing to perform re-association. MLO generally refers to a feature in advanced wireless systems (e.g., such as that defined by the IEEE 802.11-2020 specification or amendments thereof including, but not limited to 802.11be Extremely High Throughput (EHT) and the 802.11 amendment associated with Wi-Fi 8)) that enables the utilization of multiple links using individual frequency channels to transmit and receive between devices. MLO may enable concurrent utilization of multiple radio links of different frequency channels/bands by an AP, a client, or both. A device capable of MLO is generally referred to as a multi-link device (MLD).

In some cases, APs (e.g., non-collocated APs present at different physical locations) may be connected as affiliated APs of a single AP MLD. As a result, when a STA (e.g., of a non-AP MLD) transitions between these APs, the STA can bypass MLO (re) association and the 4-way handshake procedure. These techniques may be referred to as seamless roaming or make-before-break handover procedures, which may avoid data interruption and reduce delay during handover.

Seamless roaming may be considered a useful feature in ultra-high reliability (UHR) networks, enabling a client device to move from one serving AP to another without requiring reassociation. Seamless roaming may involve a UHR AP providing information related to a single mobility domain (SMD) entity (e.g., an SMD AP MLD), advertising candidate AP(s) for a client to select for roaming and possibly a transfer of context between APs. Such a handover may be initiated by a non-AP MLD (a STA), or the network may recommend to a non-AP MLD to move to a different set of (e.g., collocated or noncollocated) serving APs.

Aspects of the present disclosure provide techniques for a network entity to recommend, to a non-AP MLD, a set of APs that are suitable candidates as handover targets. The present disclosure provides mechanisms (e.g., a container/signaling framework) for providing such recommendations. In some aspects, such a recommendation may be based on extending the basic service set (BSS) Transition Management (BTM framework or the multi-link (ML) Reconfiguration framework or a combination of the two. In some aspects, such a recommendation may be based on a request by the non-AP MLD or may be unsolicited. In some cases, such frames (e.g., a request, BTM or ML reconfiguration) may be protected frames (e.g., protected with encryption).

Particular aspects of the subject matter described in this disclosure can be implemented to realize one or more of the following potential advantages. In some examples, the described techniques can be used to help ensure a non-AP MLD device transitions to a suitable AP (or set of APs) via seamless roaming. As a result, the techniques proposed herein may help ensure successful handover, improve performance after handover, and improve overall user experience.

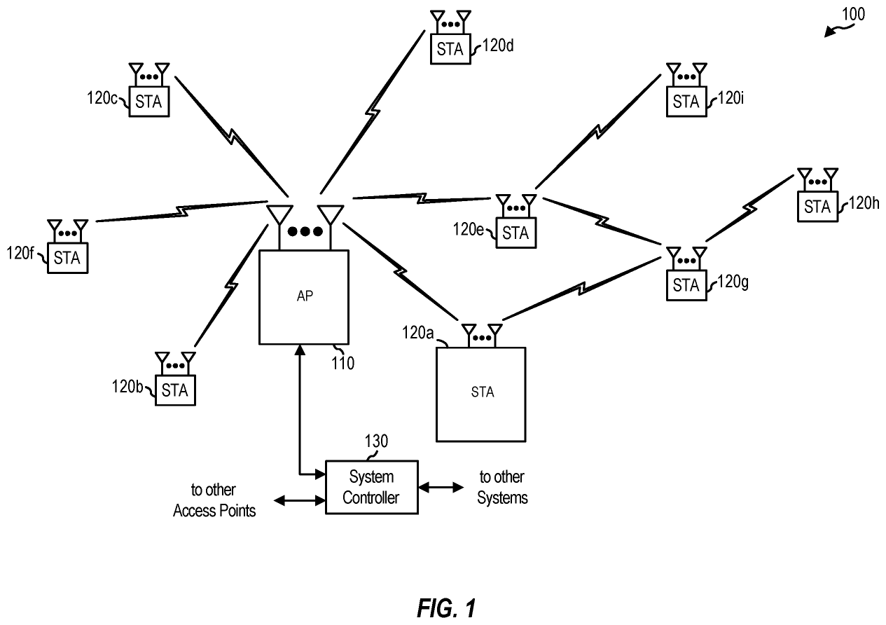

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections. In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHz), FR4a or FR4-1 (52.6 GHz-71 GHz), FR4 (52.6 GHz-114.25 GHZ), and FR5 (114.25 GHz-300 GHz).

Each of the frequency bands may include multiple sub-bands and frequency channels (also referred to as subchannels). For example, PPDUs conforming to the IEEE 802.11n, 802.11ac. 802.11ax, 802.11be and 802.11bn standard amendments may be transmitted over one or more of the 2.4 GHz. 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

### Overview of Multi-Link Devices

A multi-link device (MLD) generally refers to a single device or equipment that includes two or more station (STA) instances or entities, implemented in a physical (PHY)/medium access control (MAC) layer and configured to communicate on separate wireless links. In some examples, each MLD may include a single higher layer entity, such as a MAC Service Access Point (SAP) that may assign MAC protocol data units (MPDUs) for transmission by the separate STA instances.

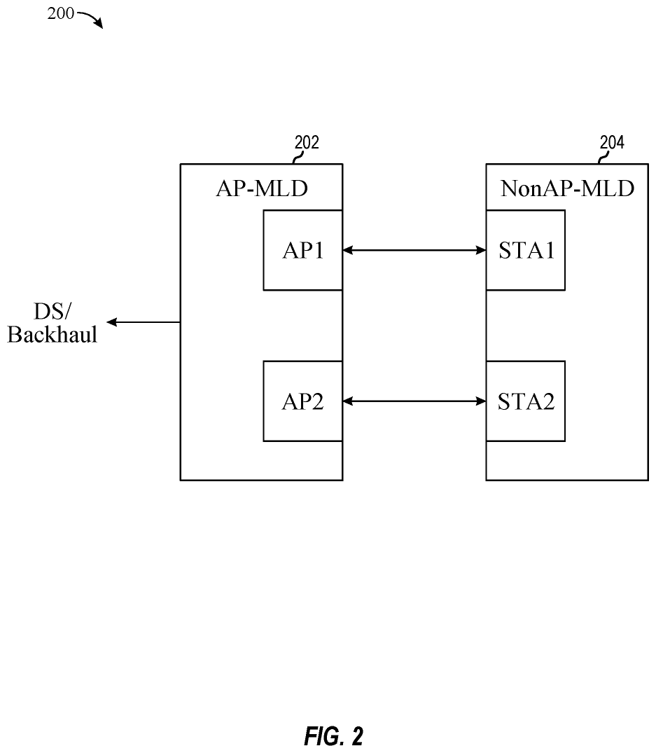

FIG. 2 depicts a block diagram of an example multi-link device (MLD) deployment.

As shown in FIG. 2, an access point (AP) MLD 202 may communicate with a non-AP MLD 204. Each of the AP MLD and non-AP MLD may include at least two STA entities 214 (hereinafter also referred to simply as “STAs”) that may communicate with associated STAs of another MLD. In an AP MLD, the STAs may be AP STAs 212 (STAs serving as APs or simply “APs”). In a non-AP MLD, the STAs may be non-AP STAs (STAs not serving as APs). As also described above, MLDs may utilize multi-link aggregation (MLA) (which includes packet level aggregation), whereby MPDUs from a same traffic ID (TID) may be sent via two or more wireless links.

Various modes of communication may be employed in MLD implementations. For example, a MLD may communicate in an Asynchronous (Async) mode or a Synchronous (Sync) mode. The Async mode provides flexibility to adapt to channel loading, allowing an MLD to perform channel access, transmit, and receive data via multiple links asynchronously. Sync mode may be preferred, however, if RF leakage exists between channels, because synchronized transmission on all links is unaffected by RF leakage.

In the Async mode, a STA/AP may count down (for example, via a random backoff (RBO)) on both wireless links. A physical layer convergence protocol (PLCP) protocol data units (PPDU) start/end may happen independently on each of the wireless links. As a result, Async mode may potentially provide latency and aggregation gains. In certain cases, relatively complex (and costly) filters may be needed (for example, in the case of 5 GHz+6 GHz aggregation).

In the Sync mode, a STA/AP may also perform a backoff countdown on multiple wireless links as part of a channel access procedure. If a first link gains access to the medium through the channel access procedure, multiple links may transmit PPDUs at the same time. Accordingly, this mode may need some restrictions to minimize in-device interference.

The Sync mode may work in 5 GHz+6 GHz aggregation and may require relatively low-filter performance, while still providing latency and aggregation gains. However, due to that STA's tiled architecture, this latency and aggregation gains may be hard to achieve.

Although not shown, a third mode of communication may include a Basic (for example, multi-primary with single link transmission) mode. In the Basic mode, a STA/AP may also count down on both wireless links. However, transmission may only occur on the wireless link that gains access to the medium. The other wireless link may be blocked by in-device interference greater than −62 decibels per milliwatt (dBm). No aggregation gains may be realized in this mode.

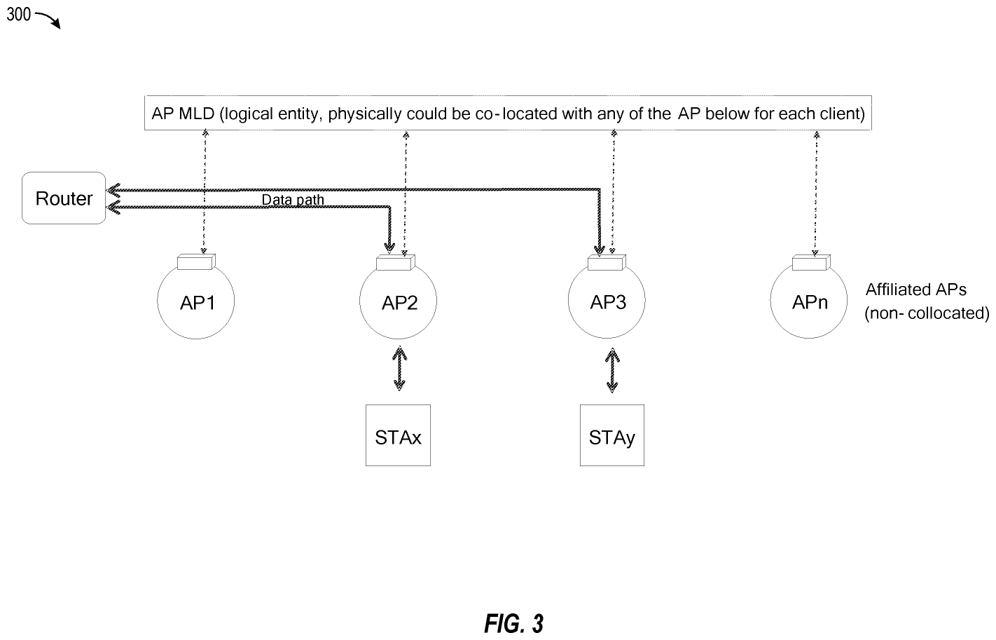

FIG. 3 depicts an example multi-link operation (MLO) architecture. As noted above, conventional wireless communication systems typically only support a break-before-make handover procedure, requiring a STA to perform an association procedure when roaming between multiple APs. This approach creates data interruption and extra delay during the handover procedure.

Aspects of the present disclosure, however, support seamless roaming (e.g., a make-before-break handover procedure), which may avoid data interruption and reduce delay during handover.

Aspects of the present disclosure may be implemented, for example, in the multi-link operation (MLO) architecture illustrated in FIG. 3. The MLO architecture of FIG. 3 may allow non-collocated APs to be affiliated with a single AP MLD 302. In this manner, an AP MLD may be considered a logical entity which is collocated physically with any of a set of non-collocated APs 312 affiliated with the AP MLD.

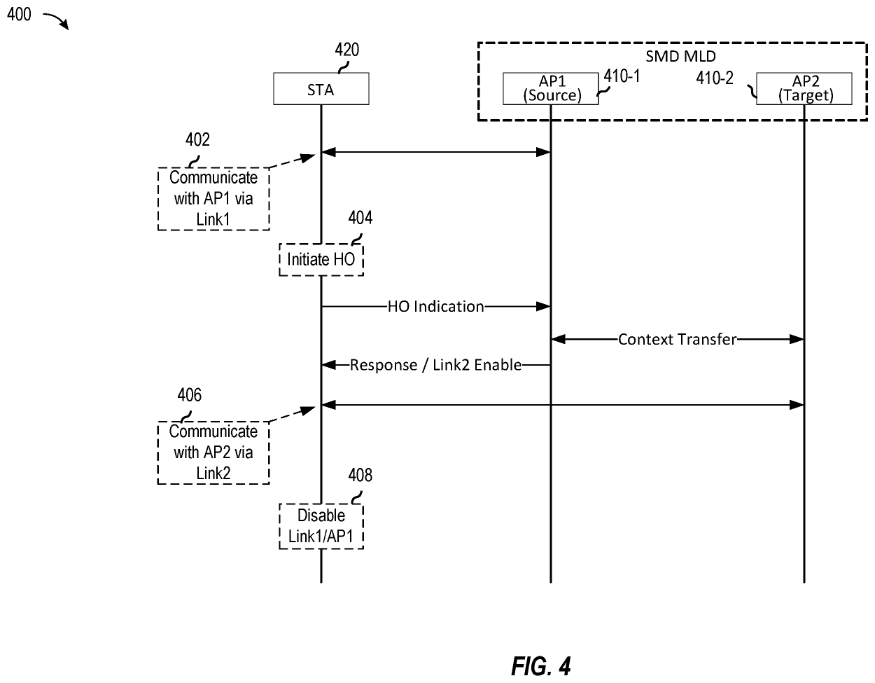

FIG. 4 depicts an example call flow diagram illustrating a station initiated handover. The example assumes a client station (STA) 420 that initiates a handover from a source AP (AP1 410-1) to a target AP (AP2 410-2), that are both affiliated with an SMD MLD.

As illustrated at 402, the STA may initially be in communication with AP1 via a first link, Link1. As illustrated at 404, the STA may initiate a handover (HO), and may send an HO indication to AP1. As will be described below, the HO indication may be sent in a message referred to as a roaming announcement initiation (RAI) message. Some other type of message referred to by a different name (other than an RAI message) may also convey an HO indication or similar type of signaling announcing initiation of a handover or seamless roaming.

After receiving the HO indication, AP1 may transfer context to AP2, to prepare AP2 to serve the STA. As noted above, the context may include management and data context. In some cases, AP1 may indicate the context transfer has been performed, for example with a response to the HO indication, which may also indicate a second link (Link 2) is enabled. As illustrated at 406, after receiving the response, the STA may communicate with AP2 via Link 2. As illustrated at 408, the STA may disable Link 1 with AP1.

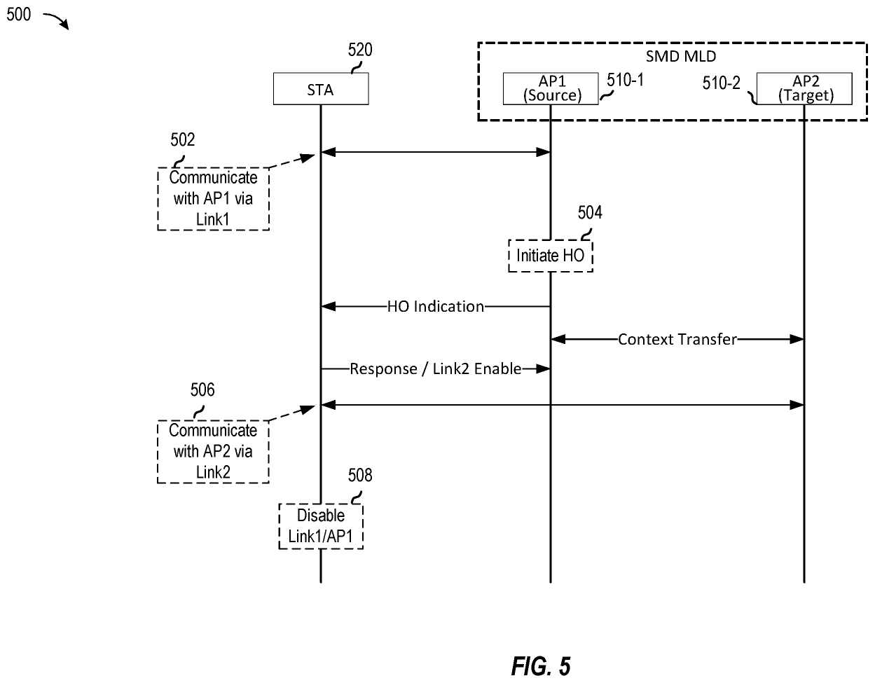

FIG. 5 depicts an example call flow diagram illustrating a network initiated handover. The example assumes a network initiated handover of a STA 520 from source AP1 510-1 to a target AP2 510-2, that are both affiliated with an SMD MLD. The signaling is similar to that shown in FIG. 4, except source AP1 assumes the role of HO initiator. In other words, AP1 sends the HO indication to the STA and the STA sends a corresponding Response. Network initiated handover may have benefits, for example, as APs may have consider information the STA may not have, such as overall network loading and/or relative loading of one or more potential target APs.

As illustrated at 502, similarly to the scenario illustrated in FIG. 4, the STA may initially be in communication with AP1 via Link1. As illustrated at 504, AP1 may then initiate an HO, and may send an HO indication to the STA (e.g., via a RAI message). After transmitting the HO indication, AP1 may transfer context to AP2, to prepare AP2 to serve the STA. In this case, the STA may signal AP1 (e.g., via a RAR message) when it is ready to enable Link 2 (e.g., after draining UL packets to AP1). As illustrated at 506, after transmitting the response, the STA may communicate with AP2 via Link 2. As illustrated at 508, the STA may disable Link 1 with AP1.

### Aspects Related to Network Recommended Seamless Roaming

Aspects of the present disclosure provide mechanisms that may enable a network entity to indicate recommendations, to a wireless station, for seamless roaming.

In the handover scenarios described herein, the source AP and target AP may both be affiliated with a single mobility domain (SMD) entity, such as an SMD AP MLD. In this context, an SMD entity generally refers to a logical entity that comprises more than one non-collocated AP device such that a non-AP device that is associated with the SMD entity can seamlessly roam (e.g., without requiring reassociation) between the AP devices affiliated with the SMD entity. In this context, an AP device (affiliated with an SMD entity) can be an AP MLD which comprises one or more affiliated APs or a single link AP. A non-AP device can be a non-AP MLD which comprises one or more affiliated non-AP STAs or a single link non-AP STA.

The source AP and target AP may be affiliated with different (normal or non-SMD) AP MLDs. An SMD AP MLD may be similar to a normal AP MLD, in that it may control multiple APs affiliated therewith. One difference, however, is that APs affiliated with the SMD AP MLD may be in different locations (non-collocated), while APs affiliated to a same normal AP MLD are typically in the same location (collocated).

One example of an SMD entity is an SMD MLD, which may refer to a logical entity that can reside, for example, on a network controller or a serving AP MLD for a particular client. For the latter case, the physical AP that provides (activates/operates) SMD MLD functionality can be different for different clients and therefore the physical location of SMD MLD can be different for different clients. Further, some operations or functionality can be split between an AP MLD and an SMD MLD. For example, functionality related to association context, block acknowledgment (BA), and/or security may reside on the SMD MLD for a particular client, while other functionality related to a Link ID may be based on the serving AP MLD. This is in contrast to a conventional station (e.g., a legacy client) such as an 802.11 be compliant non-AP MLD, where such functionalities may all reside on the physical AP MLD that is serving the that non-AP MLD. While the present disclosure refers to an entity that provides the functionality described above as an SMD MLD, entities providing the same or similar functionality may be referred to by other names.

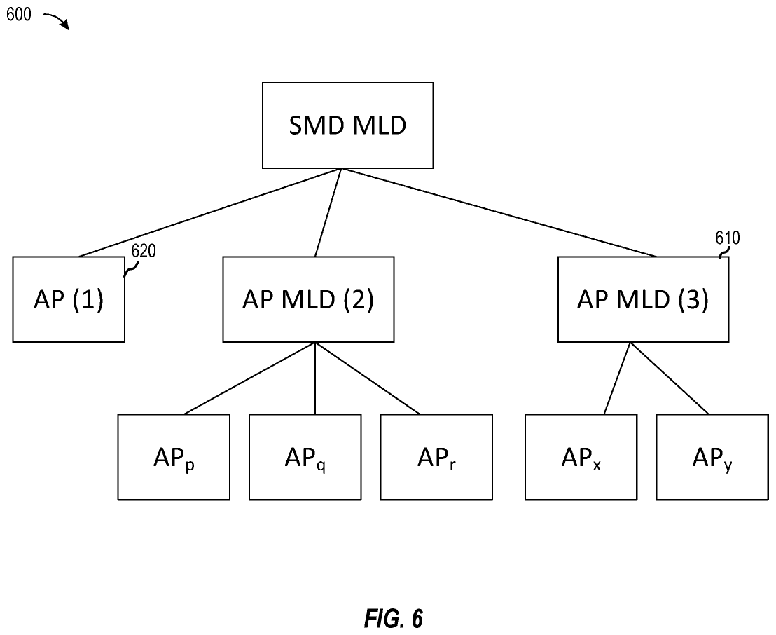

FIG. 6 depicts an example SMD MLD hierarchy 600. As illustrated, an SMD MLD may have a set of affiliated AP devices 610 and 620. For example, each affiliated AP device may be a non-MLD AP (e.g., a standalone single AP 620) or may be an AP MLD 610 with its own affiliated APs. An AP affiliated with an AP MLD that is affiliated with an SMD MLD can be thought of being (e.g., indirectly) affiliated with the SMD MLD.

As noted above, seamless roaming is a potentially useful feature in ultra-high reliability (UHR) networks, enabling a client device to seamless move from one serving AP to another without requiring reassociation. Seamless roaming may involve a UHR AP providing information related to an single mobility domain (SMD) entity (e.g., an SMD AP MLD), advertising candidate AP(s) for a client to select for roaming and possibly a transfer of context between APs. Such roaming/handover/transition may be initiated by a non-AP MLD, or the network may recommend to a non-AP MLD to move to a different set of (e.g., collocated or noncollocated) serving APs.

A set of APs may be identified as suitable candidate targets for handover because the SMD AP MLD has a global view of the extended service set (ESS). For example, an SMD AP MLD may have knowledge of loading at each affiliated AP MLD, a number of associated clients, and the like, which may help identify a set of one or more AP MLDs that are best suited for a non-AP MLD to roam to. Thus, an AP device (e.g., an AP MLD) affiliated with the SMD MLD (e.g., and currently serving the non-AP MLD) may be well suited to provide a list of recommended AP MLDs that the non-AP MLD can roam to.

Aspects of the present disclosure provide techniques for a network recommending a non-AP MLD to transition from one set of serving APs to a different set of APs. The present disclosure provides mechanisms (e.g., a container/signaling framework) for providing such recommendations. In some aspects, such a recommendation may be based on extending the basic service set (BSS) Transition Management (BTM framework or the multi-link (ML) Reconfiguration framework or a combination of the two. In some aspects, such a recommendation may be based on a request by the non-AP MLD or may be unsolicited.

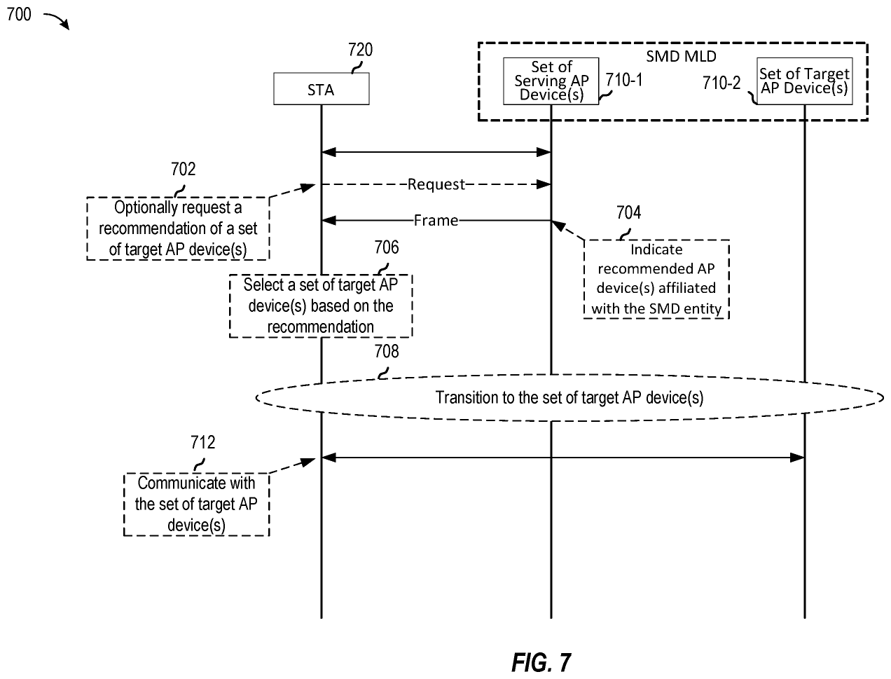

These techniques for seamless roaming recommendations proposed herein may be understood with reference to the example call flow diagram 700 of FIG. 7. In some aspects, the sets of AP devices and STA depicted in FIG. 7 may be examples of the AP 102 (e.g., an AP STA) and STA 104 depicted and described with respect to FIG. 1.

As illustrated a STA device (e.g., a non-AP MLD) 720 may be initially served by a first set of Serving AP devices 710-1.

As illustrated at 704, the first a set of serving AP device(s) may transmit a frame indicating recommended AP device(s) (e.g., a list of recommended target AP device(s)) affiliated with the SMD entity. In some aspects, the frame may be a BTM request or an ML Reconfiguration request. As illustrated at 702, in some cases, the STA device may optionally request the recommendation of a set of target AP device(s).

As illustrated at 706, the STA may select a set of target AP device(s) based on the recommendation. For example, in some aspects, the STA may perform a ML reconfiguration procedure to add/remove APs from a target AP list to match the recommended set. In some aspects, the STA may perform a delete operation before an add operation. In some aspects, the APs that are deleted may include any APs that are not a part of the recommended set. In some aspects, the APs that are added may be a subset of the recommended set.

As illustrated at 708, the STA may transition/handover/roam from the set of serving AP device(s) to the selected set of target AP device(s). As illustrated at 712, the STA may communicate with the set of target AP device(s) after transitioning to them. While not shown, such a transition may involve one or more operations described above with reference to FIG. 4 or FIG. 5 (e.g., an HO indication and context transfer).

In some systems, a non-AP STA (e.g., STA 720) may request more information regarding other candidate APs, for example. The request may be made, for example, via a query or subscription.

For example, a non-AP STA may make a query (proactively) before the non-AP STA has received a recommendation to transition to a target AP or after the AP STA has received a recommendation. The query and corresponding response including the requested information may be any type of suitable query and response, such as a multi-link probe request/multi-link probe response or Access Network Query Protocol (ANQP) query/response. In some systems, the query and/or response may use protected frames (e.g., using encryption).

In some systems, the non-AP STA may subscribe (e.g., by expressing its interest towards) for information related to a subset of candidate APs (a subscribed candidate set). In some cases, the serving AP (MLD) may provide updates related to the parameters of the subscribed candidate AP(s) in an unsolicited manner. In some cases, the serving AP may limit its recommendation to transition to the APs in the subscribed candidate set.

In some cases, the non-AP MLD/STA may only be capable of being served by a single AP MLD (e.g., all affiliated APs belong to the same collocated set). In such cases, an ML reconfiguration procedure (e.g., defined by certain wireless communications standards) may be adapted (e.g., with exceptions and/or extensions) for such a recommendation of target AP device(s).

In some aspects, an AP affiliated with the serving AP may transmit a Link Reconfiguration Notify frame containing a Reconfiguration ML IE to a non-AP STA affiliated with the non-AP MLD. An MLD MAC address field may be present in the element and may carry the MLD MAC address of the target AP MLD.

In some aspects, the Reconfiguration ML IE may not include any per-STA profile, which may indicate that all affiliated APs of the target AP MLD are recommended. In some aspects, the Reconfiguration ML IE may include per-STA profiles, each corresponding to a recommended affiliated AP of the target AP MLD. In either case, the recommended set may be all the affiliated APs of the target AP MLD.

In some cases, a non-AP MLD may be capable of being served by more than one AP MLD (e.g., the affiliated APs can belong to non-collocated set). In such cases, an AP affiliated with one of the serving AP MLDs may transmit a Link Reconfiguration Notify frame containing one or more Reconfiguration ML IE to a non-AP STA affiliated with the non-AP MLD. An MLD MAC address field may be present in the element(s) and may carry the MLD MAC address of the respective target AP MLD(s). Similarly to the case where the non-AP MLD is served by a single AP MLD, the reconfiguration ML IE may or may not include any per-STA profiles.

For scenarios where a non-AP MLD is (e.g., capable of being) served by only one AP MLD (e.g., all affiliated APs belong to the same collocated set), an AP affiliated with the serving AP may transmit, to a non-AP STA affiliated with the non-AP MLD, a BTM Request frame containing one or more Neighbor Report elements each carrying a Basic ML IE.

The Basic ML IE may or may not include per-STA profiles (e.g., based on recommendations about specific affiliated APs). In some aspects, the MLD MAC address field of the Basic ML IE may carry a MAC address of the SMD MLD. In some aspects, the MLD MAC address field of the Basic ML IE may carry a MAC address of the target AP MLD and one or more other fields indicating that the target AP MLD belongs to the same SMD MLD.

For scenarios where a non-AP MLD can be served by more than one AP MLD (i.e., the affiliated APs can belong to non-collocated set), a BTM request frame (e.g., defined by certain wireless communications standards) may be adapted (e.g., with exceptions and/or extensions) for such a recommendation of target AP device(s).

In some aspects, AP affiliated with one of the serving AP MLDs may transmit a BTM Request frame to a non-AP STA affiliated with the non-AP MLD. The BTM request frame may contain one or more Neighbor Report elements.

In some aspects, each Neighbor Report element may include a single Basic ML IE with the MLD MAC address field carrying MAC address of the SMD MLD and one or more per-STA profiles each corresponding to one or more recommended affiliated APs. For each recommended affiliated AP, a field may identify the collocated set (e.g., or the AP MLD ID or AP MLD MAC address) that the AP is affiliated with.

In some aspects, each Neighbor Report element may include one Basic ML IE for each AP MLD whose affiliated AP(s) are being recommended. For each Basic ML IE, the MLD MAC address field may carry a MAC address of the AP MLD and one or more per-STA profiles each corresponding to one or more recommended affiliated APs of that AP MLD.

Certain aspects of the present disclosure provide a plurality of options for carrying recommendations of multiple (target) AP MLDs for seamless roaming.

In some aspects, a new variant of an ML IE or Per-MLD Profiles may be included in an existing variant of ML IE (e.g., a Reconfiguration ML IE). This allows including various levels of information regarding the recommended AP MLDs. For example, by including only the MLD Control field in each Per-MLD Profile, only an identifier may be included. Alternatively, by including the MLD Info field, MLD-level common information may be provided. Similarly, by including the MLD Profile field, additional info (e.g., information regarding affiliated APs) may be provided.

In some aspects, an AP MLD ID List may be included in the Common Info field or Link Info field of an existing variant of ML IE (e.g., Reconfiguration or Basic). In such aspects, only the identifier of the recommended AP MLD is provided.

In some aspects, a separate Basic ML IE or Reconfiguration ML IE may be included for each recommended AP MLD. In such aspects, for example, the Common Info field of the Basic ML IE or Reconfiguration ML IE may allow for inclusion of the AP MLD ID subfield, which may identify the AP MLD whose information is provided. In such aspects, various levels of information regarding the recommended AP MLDs can be provided.

In some aspects, the recommendation of AP devices (e.g., AP MLDs) may be carried in a Link Reconfiguration Notify frame (e.g., which may be defined in certain wireless communications standards such as 802.11be), which may recommend an AP affiliated with the same AP MLD. In some aspects, the recommendation of AP devices may be carried in a Probe Response or (Re) Association Response as a pre-emptive candidate AP list for the non-AP MLD.

According to certain aspects of the present disclosure, the one or more recommended AP devices may not be affiliated with the SMD entity. For example, the one or more recommended AP devices may be affiliated with a different SMD entity. In such cases, reassociation may be required when performing the transitioning/handover/roaming. In other words, the techniques disclosed herein may be applicable to scenarios involving non-seamless roaming, where reassociation may be required.

According to certain aspects, rather than providing limited information of the target AP MLD(s), the serving AP MLD may send what may amount to essentially a complete profile for at least one of the indicated/recommended AP devices. In some cases, a form of inheritance may be used to convey information regarding the set of target AP MLD(s). For example, for a Link Reconfiguration Notify frame (transmitted as the first frame), inheritance may be with respect to the first per-STA/per-MLD profile.

The use of inherency in this manner may be beneficial when the serving AP MLD provides complete information of the one or more target AP MLDs, because the size of the information can become prohibitively large.

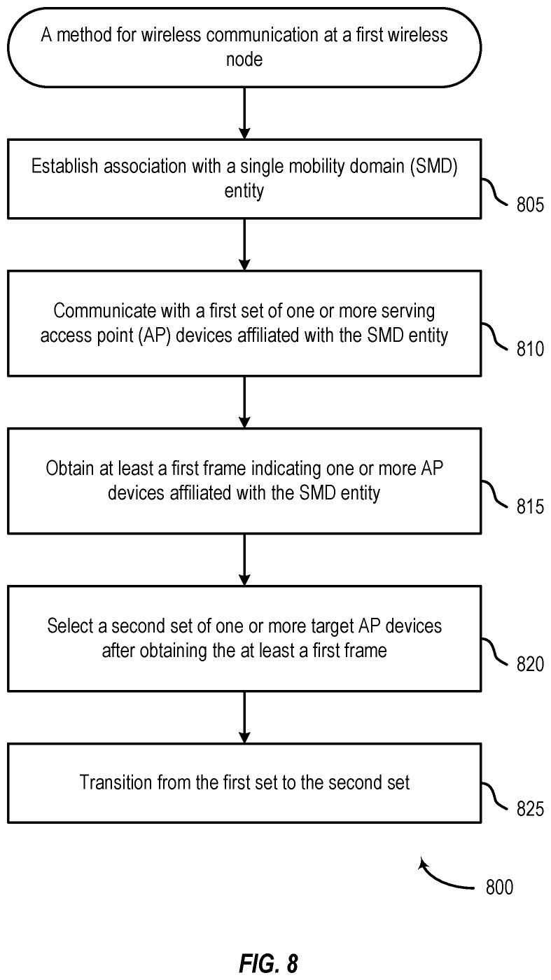

The concept of inherency may take advantage of the tendency for there to be a significant amount of duplicate information that is common to all APs of an AP MLD, along with some different (or delta) information that is specific to certain APs of that AP MLD. As described above with reference to FIG. 8, the common (duplicate) information may be sent in the actual frame, whereas the delta information may be included in per-STA profiles.

In the case of a link reconfiguration notify frame (the first frame), the inheritance can be applied with respect to a first per-STA profile/per-MLD profile. In this manner, the serving AP MLD may identify which is that per-STA profile/per-MLD profile, which can help minimize the size of the total information. The subsequent per-STA profiles may then only carry the delta information.

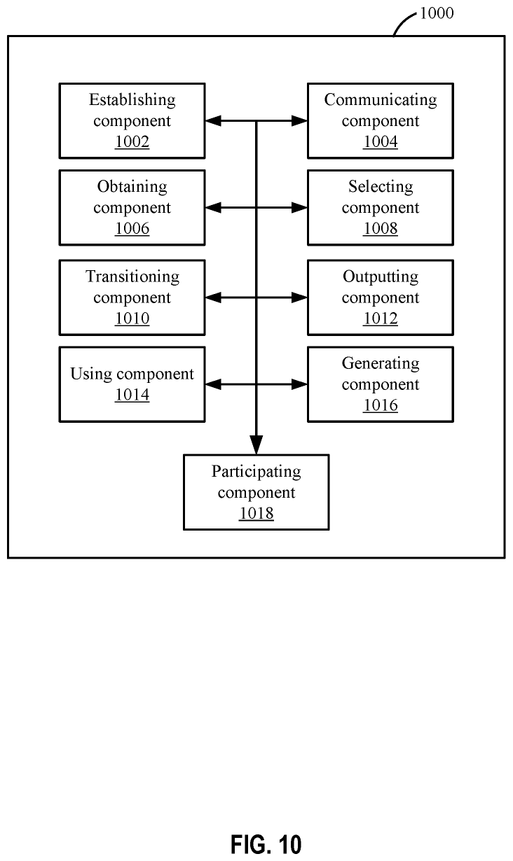

FIG. 8 shows a flowchart illustrating an example process 800 performable at a first wireless node, according to certain aspects of the present disclosure. The operations of the process 800 may be implemented by a wireless AP or a wireless STA, or its components as described herein. For example, the process 800 may be performed by a wireless communication device, such as the wireless communication device 1000 described with reference to FIG. 10, operating as or within a wireless AP or a wireless STA. In some examples, the process 800 may be performed by a wireless AP or a wireless STA, such as one of the wireless APs 102 or one of the wireless STAs 104 described with reference to FIG. 1.

Process 800 begins at step 805 with establishing association with a single mobility domain (SMD) entity.

Process 800 then proceeds to step 810 with communicating with a first set of one or more serving access point (AP) devices affiliated with the SMD entity.

Process 800 then proceeds to step 815 with obtaining at least a first frame indicating one or more AP devices affiliated with the SMD entity.

Process 800 then proceeds to step 820 with selecting a second set of one or more target AP devices after obtaining the at least a first frame.

Process 800 then proceeds to step 825 with transitioning from the first set to the second set.

In some aspects, the transition is performed in a manner that is independent of reassociation with the SMD entity.

In some aspects, the process 800 further includes outputting a request for the first frame, wherein the first frame is obtained after outputting the request.

In some aspects, the selecting comprises at least one of: deleting one or more AP devices from a list of target AP devices; or adding one or more AP devices to the list of target AP devices.

In some aspects, the added one or more AP devices comprise a subset of the one or more AP devices indicated by the frame.

In some aspects, the first frame comprises a link reconfiguration notify frame.

In some aspects, the link reconfiguration notify frame conveys at least one multi-link (ML) information element (IE).

In some aspects, the first frame comprises a basic service set (BSS) Transition Management (BTM) request frame.

In some aspects, the BTM request frame conveys at least one Neighbor Report information element (IE).

In some aspects, the first frame includes one or more fields that indicate at least one of: a media access control (MAC) address associated with the SMD entity; at least one MAC address associated with at least one target AP multi-link device (MLD); that the at least one target AP MLD belongs to the SMD entity; an identifier (ID) of the at least one target AP MLD; or one or more station (STA) profiles corresponding to the one or more AP devices indicated by the frame.

In some aspects, the first frame conveys a STA profile for at least one of the indicated AP devices.

In some aspects, the first frame comprises: at least one of a first one or more fields or a first one or more elements that convey information common to a plurality of the indicated AP devices; and at least one of a second one or more fields or a second one or more elements that convey information specific to one of the indicated AP devices.

In some aspects, the first one or more fields and one or more elements are carried in a first STA profile; and the second one or more fields and one or more elements are carried in a second STA profile.

In some aspects, the first STA profile occurs, in the first frame, before the second STA profile.

In some aspects, the process 800 further includes outputting a request for information regarding one or more of the one or more AP devices indicated in the first frame.

In some aspects, the process 800 further includes obtaining the information after outputting the request.

In some aspects, the process 800 further includes using the information when selecting the second set of one or more target AP devices.

In one aspect, process 800, or any aspect related to it, may be performed by an apparatus, such as communications device 1000 of FIG. 10, which includes various components operable, configured, or adapted to perform the process 800. Communications device 1000 is described below in further detail.

Note that FIG. 8 is just one example of a method, and other methods including fewer, additional, or alternative steps are possible consistent with this disclosure.

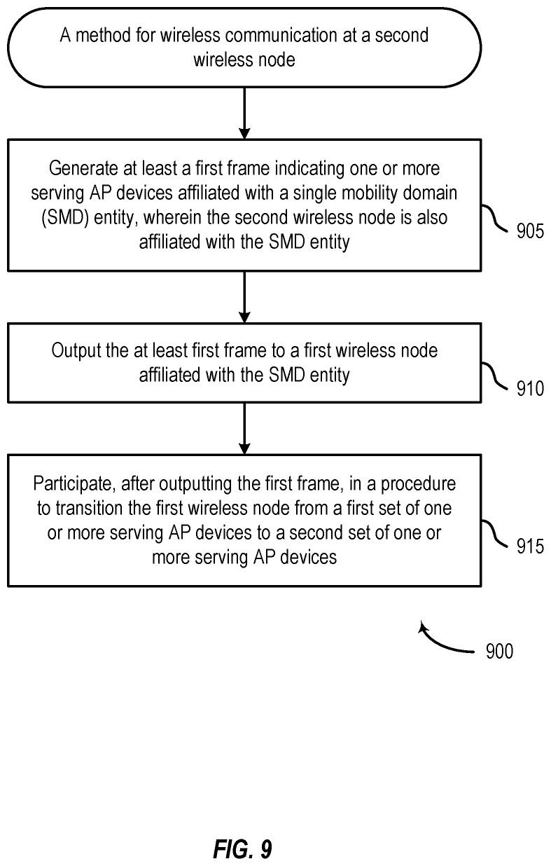

FIG. 9 shows a flowchart illustrating an example process 900 performable at a second wireless node, according to certain aspects of the present disclosure. The operations of the process 900 may be implemented by a wireless AP or a wireless STA, or its components as described herein. For example, the process 900 may be performed by a wireless communication device, such as the wireless communication device 1000 described with reference to FIG. 10, operating as or within a wireless AP or a wireless STA. In some examples, the process 800 may be performed by a wireless AP or a wireless STA, such as one of the wireless APs 102 or one of the wireless STAs 104 described with reference to FIG. 1.

Process 900 begins at step 905 with generating at least a first frame indicating one or more serving AP devices affiliated with a single mobility domain (SMD) entity, wherein the second wireless node is also affiliated with the SMD entity.

Process 900 then proceeds to step 910 with outputting the at least the first frame to a first wireless node affiliated with the SMD entity.

Process 900 then proceeds to step 915 with participating, after outputting the first frame, in a procedure to transition the first wireless node from a first set of one or more serving AP devices to a second set of one or more serving AP devices.

In some aspects, the process 900 further includes obtaining a request for the first frame, wherein the first frame is outputted after obtaining the request.

In some aspects, the first frame comprises a link reconfiguration notify frame.

In some aspects, the link reconfiguration notify frame conveys at least one multi-link (ML) information element (IE).

In some aspects, the first frame comprises a basic service set (BSS) Transition Management (BTM) request frame.

In some aspects, the BTM request frame conveys at least one Neighbor Report information element (IE).

In some aspects, the first frame includes one or more fields that indicate at least one of: a media access control (MAC) address associated with the SMD entity; at least one MAC address associated with at least one target AP multi-link device (MLD); that the at least one target AP MLD belongs to the SMD entity; an identifier (ID) of the at least one target AP MLD; or one or more station (STA) profiles corresponding to the one or more AP devices indicated by the frame.

In some aspects, the first frame conveys a STA profile for at least one of the indicated AP devices.

In some aspects, the first frame comprises: at least one of a first one or more fields or a first one or more elements that convey information common to a plurality of the indicated AP devices; and at least one of a second one or more fields or a second one or more elements that convey information specific to one of the indicated AP devices.

In some aspects, the first one or more fields and one or more elements are carried in a first STA profile; and the second one or more fields and one or more elements are carried in a second STA profile.

In some aspects, the first STA profile occurs, in the first frame, before the second STA profile.

In some aspects, the one or more serving AP devices indicated in the first frame comprise at least one single AP MLD is affiliated with a set of collocated APs.

In some aspects, the one or more serving AP devices indicated in the first frame comprise at least two AP MLDs affiliated with a set of non-collocated APs.

In some aspects, the process 900 further includes obtaining a request for information regarding one or more of the one or more AP devices indicated in the first frame.

In some aspects, the process 900 further includes outputting the information after obtaining the request.

In one aspect, process 900, or any aspect related to it, may be performed by an apparatus, such as communications device 1000 of FIG. 10, which includes various components operable, configured, or adapted to perform the process 900. Communications device 1000 is described below in further detail.

Note that FIG. 9 is just one example of a method, and other methods including fewer, additional, or alternative steps are possible consistent with this disclosure.

FIG. 10 shows a block diagram of an example wireless communication device 1000 that supports techniques disclosed herein, such as techniques that enable a network entity to indicate recommendations, to a wireless station, for seamless roaming. In some examples, the wireless communication device 1000 is configured to perform the process 800 described with reference to FIG. 8. In some examples, the wireless communication device 1000 is configured to perform the process 900 described with reference to FIG. 9. The wireless communication device 1000 may include one or more chips, SoCs, chipsets, packages, components or devices that individually or collectively constitute or comprise a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1000 may transmit the information output from the chip. In such an example, the second interface may refer to an interface between the processing system of the chip and a reception component, such that the device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP or a STA, such as the AP 102 or the STA 104 described with reference to FIG. 1. In some other examples, the wireless communication device 1000 can be an AP or a STA that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes an establishing component 1002, a communicating component 1004, an obtaining component 1006, a selecting component 1008, a transitioning component 1010, an outputting component 1012, a using component 1014, a generating component 1016, and a participating component 1018. Portions of one or more of the components 1002, 1004, 1006, 1008, 1010, 1012, 1014, 1016, and 1018 may be implemented at least in part in hardware or firmware. For example, the obtaining component 1006 may be implemented at least in part by a processor or a modem. In some examples, portions of one or more of the components 1002, 1004, 1006, 1008, 1010, 1012, 1014, 1016, and 1018 may be implemented at least in part by a processor and software in the form of processor-executable code stored in a memory.

In some implementations, the processor may be a component of a processing system. A processing system may generally refer to a system or series of machines or components that receives inputs and processes the inputs to produce a set of outputs (which may be passed to other systems or components of, for example, the wireless communication device 1000). For example, a processing system of the wireless communication device 1000 may refer to a system including the various other components or subcomponents of the wireless communication device 1000, such as the processor, or a transceiver, or a communications manager, or other components or combinations of components of the wireless communication device 1000. The processing system of the wireless communication device 1000 may interface with other components of the wireless communication device 1000, and may process information received from other components (such as inputs or signals) or output information to other components. For example, a chip or modem of the wireless communication device 1000 may include a processing system, a first interface to output information and a second interface to obtain information. In some implementations, the first interface may refer to an interface between the processing system of the chip or modem and a transmitter, such that the wireless communication device 1000 may transmit information output from the chip or modem. In some implementations, the second interface may refer to an interface between the processing system of the chip or modem and a receiver, such that the wireless communication device 1000 may obtain information or signal inputs, and the information may be passed to the processing system. A person having ordinary skill in the art will readily recognize that the first interface also may obtain information or signal inputs, and the second interface also may output information or signal outputs.

### Example Clauses

Implementation examples are described in the following numbered clauses:

Clause 1: A method for wireless communication at a first wireless node, comprising: establishing association with a single mobility domain (SMD) entity; communicating with a first set of one or more serving access point (AP) devices affiliated with the SMD entity; obtaining at least a first frame indicating one or more AP devices affiliated with the SMD entity; selecting a second set of one or more target AP devices after obtaining the at least a first frame; and transitioning from the first set to the second set.

Clause 2: The method of Clause 1, wherein the transition is performed in a manner that is independent of reassociation with the SMD entity.

Clause 3: The method of any one of Clauses 1-2, further comprising and outputting a request for the first frame, wherein the first frame is obtained after outputting the request.

Clause 4: The method of any one of Clauses 1-3, wherein the selecting comprises at least one of: deleting one or more AP devices from a list of target AP devices; or adding one or more AP devices to the list of target AP devices.

Clause 5: The method of Clause 4, wherein the added one or more AP devices comprise a subset of the one or more AP devices indicated by the frame.

Clause 6: The method of any one of Clauses 1-5, wherein the first frame comprises a link reconfiguration notify frame.

Clause 7: The method of Clause 6, wherein the link reconfiguration notify frame conveys at least one multi-link (ML) information element (IE).

Clause 8: The method of any one of Clauses 1-7, wherein the first frame comprises a basic service set (BSS) Transition Management (BTM) request frame.

Clause 9: The method of Clause 8, wherein the BTM request frame conveys at least one Neighbor Report information element (IE).

Clause 10: The method of any one of Clauses 1-9, wherein the first frame includes one or more fields that indicate at least one of: a media access control (MAC) address associated with the SMD entity; at least one MAC address associated with at least one target AP multi-link device (MLD); that the at least one target AP MLD belongs to the SMD entity; an identifier (ID) of the at least one target AP MLD; or one or more station (STA) profiles corresponding to the one or more AP devices indicated by the frame.

Clause 11: The method of any one of Clauses 1-10, wherein the first frame conveys a STA profile for at least one of the indicated AP devices.

Clause 12: The method of Clause 11, wherein the first frame comprises: at least one of a first one or more fields or a first one or more elements that convey information common to a plurality of the indicated AP devices; and at least one of a second one or more fields or a second one or more elements that convey information specific to one of the indicated AP devices.

Clause 13: The method of Clause 12, wherein: the first one or more fields and one or more elements are carried in a first STA profile; and the second one or more fields and one or more elements are carried in a second STA profile.

Clause 14: The method of Clause 13, wherein: the first STA profile occurs, in the first frame, before the second STA profile.

Clause 15: The method of any one of Clauses 1-14, further comprising: outputting a request for information regarding one or more of the one or more AP devices indicated in the first frame; obtaining the information after outputting the request; and using the information when selecting the second set of one or more target AP devices.

Clause 16: A method for wireless communication at a second wireless node, comprising: generating at least a first frame indicating one or more serving AP devices affiliated with a single mobility domain (SMD) entity, wherein the second wireless node is also affiliated with the SMD entity; outputting the at least the first frame to a first wireless node affiliated with the SMD entity; and participating, after outputting the first frame, in a procedure to transition the first wireless node from a first set of one or more serving AP devices to a second set of one or more serving AP devices.

Clause 17: The method of Clause 16, further comprising and obtaining a request for the first frame, wherein the first frame is outputted after obtaining the request.

Clause 18: The method of any one of Clauses 16-17, wherein the first frame comprises a link reconfiguration notify frame.

Clause 19: The method of Clause 18, wherein the link reconfiguration notify frame conveys at least one multi-link (ML) information element (IE).

Clause 20: The method of any one of Clauses 16-19, wherein the first frame comprises a basic service set (BSS) Transition Management (BTM) request frame.

Clause 21: The method of Clause 20, wherein the BTM request frame conveys at least one Neighbor Report information element (IE).

Clause 22: The method of any one of Clauses 16-21, wherein the first frame includes one or more fields that indicate at least one of: a media access control (MAC) address associated with the SMD entity; at least one MAC address associated with at least one target AP multi-link device (MLD); that the at least one target AP MLD belongs to the SMD entity; an identifier (ID) of the at least one target AP MLD; or one or more station (STA) profiles corresponding to the one or more AP devices indicated by the frame.

Clause 23: The method of any one of Clauses 16-22, wherein the first frame conveys a STA profile for at least one of the indicated AP devices.

Clause 24: The method of Clause 23, wherein the first frame comprises: at least one of a first one or more fields or a first one or more elements that convey information common to a plurality of the indicated AP devices; and at least one of a second one or more fields or a second one or more elements that convey information specific to one of the indicated AP devices.

Clause 25: The method of Clause 24, wherein: the first one or more fields and one or more elements are carried in a first STA profile; and the second one or more fields and one or more elements are carried in a second STA profile.

Clause 26: The method of Clause 25, wherein: the first STA profile occurs, in the first frame, before the second STA profile.

Clause 27: The method of any one of Clauses 16-26, wherein the one or more serving AP devices indicated in the first frame comprise at least one single AP MLD is affiliated with a set of collocated APs.

Clause 28: The method of any one of Clauses 16-27, wherein the one or more serving AP devices indicated in the first frame comprise at least two AP MLDs affiliated with a set of non-collocated APs.

Clause 29: The method of any one of Clauses 16-28, further comprising: obtaining a request for information regarding one or more of the one or more AP devices indicated in the first frame; and outputting the information after obtaining the request.

Clause 30: An apparatus, comprising: at least one memory comprising executable instructions; and at least one processor configured to execute the executable instructions and cause the apparatus to perform a method in accordance with any one of Clauses 1-29.

Clause 31: An apparatus, comprising means for performing a method in accordance with any one of Clauses 1-29.

Clause 32: A non-transitory computer-readable medium comprising executable instructions that, when executed by at least one processor of an apparatus, cause the apparatus to perform a method in accordance with any one of Clauses 1-29.

Clause 33: A computer program product embodied on a computer-readable storage medium comprising code for performing a method in accordance with any one of Clauses 1-29.

Clause 34: A wireless station, comprising: at least one transceiver; at least one memory comprising executable instructions; and at least one processor configured to execute the executable instructions and cause the apparatus to perform a method in accordance with any one of Clauses 1-15, wherein the at least one transceiver is configured to receive the first frame.

Clause 35: An access point (AP), comprising: at least one transceiver; at least one memory comprising executable instructions; and at least one processor configured to execute the executable instructions and cause the apparatus to perform a method in accordance with any one of Clauses 16-29, wherein the at least one transceiver is configured to transmit the first frame.

### ADDITIONAL CONSIDERATIONS

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Means for establishing, means for communicating, means for obtaining, means for selecting, means for transitioning, means for outputting, means for using, means for generating, means for participating, means for deleting, and means for adding may comprise one or more processors, such as one or more of the processors described above with reference to FIG. 10.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication, comprising:
at least one memory comprising computer-executable instructions; and
one or more processors configured to execute the computer-executable instructions and cause the apparatus to:
establish association with a single mobility domain (SMD) entity;
communicate with a first set of one or more serving access point (AP) devices affiliated with the SMD entity;
obtain at least a first frame indicating one or more AP devices affiliated with the SMD entity;
select a second set of one or more target AP devices after obtaining the at least a first frame; and
transition from the first set to the second set.

2. The apparatus of claim 1, wherein the transition is performed in a manner that is independent of reassociation with the SMD entity.

3. The apparatus of claim 1, wherein the one or more processors are further configured to cause the apparatus to:
output a request for the first frame, wherein the first frame is obtained after outputting the request.

4. The apparatus of claim 1, wherein in order to select, the one or more processors are further configured to cause the apparatus to at least one of:
delete one or more AP devices from a list of target AP devices; or
add one or more AP devices to the list of target AP devices.

5. The apparatus of claim 4, wherein the added one or more AP devices comprise a subset of the one or more AP devices indicated by the frame.

6. The apparatus of claim 1, wherein the first frame comprises a link reconfiguration notify frame.

7. The apparatus of claim 6, wherein the link reconfiguration notify frame conveys at least one multi-link (ML) information element (IE).

8. The apparatus of claim 1, wherein the first frame comprises a basic service set (BSS) Transition Management (BTM) request frame.

9. The apparatus of claim 8, wherein the BTM request frame conveys at least one Neighbor Report information element (IE).

10. The apparatus of claim 1, wherein the first frame includes one or more fields that indicate at least one of: a media access control (MAC) address associated with the SMD entity; at least one MAC address associated with at least one target AP multi-link device (MLD); that the at least one target AP MLD belongs to the SMD entity; an identifier (ID) of the at least one target AP MLD; or one or more station (STA) profiles corresponding to the one or more AP devices indicated by the frame.

11. The apparatus of claim 1, wherein the first frame conveys a STA profile for at least one of the indicated AP devices.

12. The apparatus of claim 11, wherein the first frame comprises: at least one of a first one or more fields or a first one or more elements that convey information common to a plurality of the indicated AP devices; and at least one of a second one or more fields or a second one or more elements that convey information specific to one of the indicated AP devices.

13. The apparatus of claim 12, wherein the first one or more fields and one or more elements are carried in a first STA profile; and the second one or more fields and one or more elements are carried in a second STA profile.

14. The apparatus of claim 1, wherein the one or more processors are further configured to cause the apparatus to:
output a request for information regarding one or more of the one or more AP devices indicated in the first frame;
obtain the information after outputting the request; and
use the information when selecting the second set of one or more target AP devices.

15. The apparatus of claim 1, further comprising at least one transceiver configured to receive the first frame, wherein the apparatus is configured as a wireless station.

16. An apparatus for wireless communication, comprising:
at least one memory comprising computer-executable instructions; and
one or more processors configured to execute the computer-executable instructions and cause the apparatus to:
generate at least a first frame indicating one or more serving AP devices affiliated with a single mobility domain (SMD) entity, wherein the apparatus is also affiliated with the SMD entity;
output the at least the first frame to a wireless node affiliated with the SMD entity; and
participate, after outputting the first frame, in a procedure to transition the wireless node from a first set of one or more serving AP devices to a second set of one or more serving AP devices.

17. The apparatus of claim 16, wherein the one or more processors are further configured to cause the apparatus to:
obtain a request for the first frame, wherein the first frame is outputted after obtaining the request.

18. The apparatus of claim 16, wherein the first frame comprises a link reconfiguration notify frame.

19. The apparatus of claim 18, wherein the link reconfiguration notify frame conveys at least one multi-link (ML) information element (IE).

20. The apparatus of claim 16, wherein the first frame comprises a basic service set (BSS) Transition Management (BTM) request frame.

21. The apparatus of claim 20, wherein the BTM request frame conveys at least one Neighbor Report information element (IE).

22. The apparatus of claim 16, wherein the first frame includes one or more fields that indicate at least one of: a media access control (MAC) address associated with the SMD entity; at least one MAC address associated with at least one target AP multi-link device (MLD); that the at least one target AP MLD belongs to the SMD entity; an identifier (ID) of the at least one target AP MLD; or one or more station (STA) profiles corresponding to the one or more AP devices indicated by the frame.

23. The apparatus of claim 16, wherein the first frame conveys a STA profile for at least one of the indicated AP devices.

24. The apparatus of claim 23, wherein:
the first frame comprises: at least one of a first one or more fields or a first one or more elements that convey information common to a plurality of the indicated AP devices; and at least one of a second one or more fields or a second one or more elements that convey information specific to one of the indicated AP devices;
the first one or more fields and one or more elements are carried in a first STA profile;
the second one or more fields and one or more elements are carried in a second STA profile; and
the first STA profile occurs, in the first frame, before the second STA profile.

25. The apparatus of claim 16, wherein the one or more serving AP devices indicated in the first frame comprise at least one single AP MLD is affiliated with a set of collocated APs.

26. The apparatus of claim 16, wherein the one or more serving AP devices indicated in the first frame comprise at least two AP MLDs affiliated with a set of non-collocated APs.

27. The apparatus of claim 16, wherein the one or more processors are further configured to cause the apparatus to:
obtain a request for information regarding one or more of the one or more AP devices indicated in the first frame; and
output the information after obtaining the request.

28. The apparatus of claim 16, further comprising at least one transceiver configured to transmit the first frame, wherein the apparatus is configured as an access point (AP).

29. A method for wireless communication at a first wireless node, comprising:
establishing association with a single mobility domain (SMD) entity;
communicating with a first set of one or more serving access point (AP) devices affiliated with the SMD entity;
obtaining at least a first frame indicating one or more AP devices affiliated with the SMD entity;
selecting a second set of one or more target AP devices after obtaining the at least the first frame; and
transitioning from the first set to the second set.
